(19) United States
(12) Patent Application Publication
(10) Pub. No.: US 2014/0121888 A1
(43) Pub. Date: May 1, 2014

(54) METHOD, SERVER AND SYSTEM FOR VEHICLE DIAGNOSIS

(71) Applicant: Beijing Wiselink Software Co., Ltd, Beijing (CN)

(72) Inventors: Yudong GUO, Beijing (CN); Jifeng LIU, Beijing (CN); Jiliang LI, Beijing (CN)

(73) Assignee: Beijing Wiselink Software Co., Ltd., Beijing (CN)

(21) Appl. No.: 14/065,905

(22) Filed: Oct. 29, 2013

(30) Foreign Application Priority Data
Oct. 29, 2012 (CN) 201210422574.9
Oct. 23, 2013 (CN) 201310504534.3

(51) Int. Cl. G07C 5/00

(52) U.S. Cl. CPC G07C 5/008
USPC 701/31.4

(57) ABSTRACT

A method, a server and a system for vehicle diagnosis are provided. The method for vehicle diagnosis comprises: a diagnosis server remotely receiving a fault code sent by a vehicle-side terminal and recording a sending device identifier; analyzing the received fault code to obtain a fault diagnosis result; pushing the fault diagnosis result to a corresponding vehicle owner according to the sending device identifier. By adopting the above technical solution, the vehicle owner can know fault situation of the vehicle in time without moving the vehicle to a certain maintenance site, and further decide whether to make a repair or maintenance according to the obtained fault situation, which not only reduces the unnecessary time waste but also effectively reduces security hidden trouble and reduces accident occurrence probability.

### FIELD OF THE INVENTION

The present application generally relates to the technical field of Internet application, and in particular to a method, a server and a system for vehicle diagnosis.

### BACKGROUND OF THE INVENTION

Vehicle diagnosis means to detect each of components of a vehicle without disassembling or detaching the vehicle, and when detecting a faulty component, to further analyze the reason causing the fault. The common vehicle diagnosis includes the diagnosis of vehicle body, the diagnosis of engine, and the diagnosis of vehicle exhaust contaminant and noise, etc.

An electronic control unit (ECU) mounted in a vehicle generally has a fault diagnosis function for detecting the operation status of each of components of the vehicle; when detecting a fault occurred in a component of the vehicle, generating a fault code according to the type of the fault, and storing the fault code into a random access memory (RAM) of the ECU. According to a conventional vehicle diagnosis method, if the vehicle owner wants to know the fault situation, he/she needs to move the vehicle to a certain vehicle service agency. The maintenance personnel of the vehicle service agency connects a maintenance computer to the ECU via a ECU's own interface according to a certain operation specification, and thereby the fault code stored in the ECU is read and analyzed by the maintenance computer. Then the maintenance personnel manually diagnose the fault of the vehicle by referring to related technical material and inform it to the vehicle owner.

Although the conventional vehicle diagnosis method can detect the vehicle status, the vehicle owner must move the vehicle to a certain service agency to know the detailed diagnosis information, and the owner can not know the vehicle status anytime and anywhere. Further, since the vehicle owner can not know the vehicle status in time, in most cases, he/she will not move the vehicle to the vehicle service agency to make a fault diagnosis on his/her own initiative. Therefore employment of the conventional vehicle diagnosis method often results in that the vehicle owner moves the vehicle to the vehicle service agency to make a diagnosis only when the fault of the vehicle is so severe that the vehicle cannot be used normally, and thereby it may cause hidden trouble to driving security and vehicle maintenance.

### SUMMARY OF THE INVENTION

The present application provides a method, a server and a system for vehicle diagnosis by which the vehicle owner can know the fault situation of the vehicle conveniently in time. In order to achieve the above object, the technical solutions of the present application are implemented as follows.

The present application provides a method for vehicle diagnosis comprising:

after a remote communication connection between a diagnosis server and a vehicle-side terminal being established, the diagnosis server remotely receiving a fault code sent by the vehicle-side terminal and recording a sending device identifier, wherein the vehicle-side terminal obtains the fault code from an electronic control unit in a vehicle;

analyzing the received fault code to obtain a fault diagnosis result;

pushing the fault diagnosis result to a corresponding vehicle owner according to the sending device identifier.

According to an embodiment of the present application, the vehicle-side terminal comprises a diagnosis terminal, and the diagnosis server remotely receiving the fault code sent by the vehicle-side terminal comprises:

after the diagnosis server establishing a remote communication connection to the diagnosis terminal, receiving the fault code sent by the diagnosis terminal

According to an embodiment of the present application, the vehicle-side terminal comprises a diagnosis terminal and a communication terminal, and the diagnosis server remotely receiving the fault code sent by the vehicle-side terminal comprises:

after the diagnosis server establishing a remote communication connection to the communication terminal, receiving the fault code sent by the communication terminal;

wherein, the communication terminal obtains the fault code from the diagnosis terminal

According to an embodiment of the present application, the pushing of the fault diagnosis result to the corresponding vehicle owner according to the sending device identifier comprises:

returning the fault diagnosis result to a sending device according to the sending device identifier.

According to an embodiment of the present application, the pushing of the fault diagnosis result to the corresponding vehicle owner according to the sending device identifier comprises:

sending the fault diagnosis result to a device associated with the sending device according to the sending device identifier.

According to an embodiment of the present application,

the sending device is a diagnosis terminal;

the device associated with the sending device is a mobile device connected to the diagnosis terminal for presenting the fault diagnosis result to the vehicle owner.

According to an embodiment of the present application, the pushing of the fault diagnosis result to the corresponding vehicle owner according to the sending device identifier comprises:

according to the sending device identifier, obtaining contact information of the vehicle owner associated with the device;

according to the obtained contact information of the vehicle owner, pushing the fault diagnosis result to the corresponding vehicle owner.

According to an embodiment of the present application, the method further comprises:

receiving an data package for requesting upgrade sent by a diagnosis terminal, wherein the data package carries type parameters of a vehicle and version parameters of a diagnosis terminal software;

according to the type parameters of the vehicle, determining software of newest version conforming to the type;

pushing software of newest version to the diagnosis terminal in case that the current version of the diagnosis terminal software is not the newest version.

According to an embodiment of the present application, the method further comprises:

receiving an data package for requesting upgrade sent by a communication terminal, wherein the data package carries type parameters of a vehicle and version parameters of a communication terminal software;

according to the type parameters of the vehicle, determining software of newest version conforming to the type;

pushing the software of newest version to the communication terminal in case that the current version of the communication terminal software is not the newest version.

According to an embodiment of the present application, the method further comprises:

after upgrading the communication terminal software to the software of newest version, importing a data package for upgrading the diagnosis terminal software from the communication terminal to the diagnosis terminal

The present application also provides a server for vehicle diagnosis comprising:

a receiving module for, after a remote communication connection between a diagnosis server and a vehicle-side terminal is established, remotely receiving a fault code sent by the vehicle-side terminal and recording a sending device identifier, wherein the vehicle-side terminal obtains the fault code from an electronic control unit in a vehicle;

a diagnosis and analysis module for analyzing the received fault code to obtain a fault diagnosis result;

a pushing module for pushing the fault diagnosis result to a corresponding vehicle owner according to the sending device identifier.

According to an embodiment of the present application, the pushing module comprises:

a device identifier obtaining sub-module for obtaining the sending device identifier,

a pushing sub-module for returning the fault diagnosis result to a sending device according to the obtained sending device identifier.

According to an embodiment of the present application, the pushing module comprises:

a device identifier obtaining sub-module for obtaining the sending device identifier,

a pushing sub-module for sending the fault diagnosis result to a device associated with the sending device according to the obtained sending device identifier.

According to an embodiment of the present application,

the sending device is a diagnosis terminal;

the device associated with the sending device is a mobile device connected to the diagnosis terminal for presenting the fault diagnosis result to the vehicle owner.

According to an embodiment of the present application, the pushing module comprises:

a contact information obtaining sub-module for, according to the sending device identifier, obtaining contact information of the vehicle owner associated with the device;

a pushing sub-module for, according to the obtained contact information of the vehicle owner, pushing the fault diagnosis result to the corresponding vehicle owner.

The present application also provides a system for vehicle diagnosis comprising:

a vehicle-side terminal for sending a fault code to a diagnosis server after determining a fault occurred in a vehicle;

the diagnosis server comprising:

a receiving module for, after a remote communication connection between the diagnosis server and the vehicle-side terminal being established, remotely receiving the fault code sent by the vehicle-side terminal and recording a sending device identifier, wherein the vehicle-side terminal obtains the fault code from an electronic control unit in a vehicle;

a diagnosis and analysis module for analyzing the received fault code to obtain a fault diagnosis result;

a pushing module for pushing the fault diagnosis result to a corresponding vehicle owner according to the sending device identifier.

According to an embodiment of the present application, the vehicle-side terminal comprises a diagnosis terminal, wherein,

after a remote communication connection between the diagnosis terminal and the diagnosis server being established, the diagnosis terminal sends the fault code to the diagnosis server.

According to an embodiment of the present application, the vehicle-side terminal comprises a diagnosis terminal and a communication terminal,

the communication terminal obtains the fault code from the diagnosis terminal;

after a remote communication connection between the communication terminal and the diagnosis server being established, the communication terminal sends the fault code to the diagnosis server.

According to an embodiment of the present application, the pushing module comprises:

a device identifier obtaining sub-module for obtaining the sending device identifier,

a pushing sub-module for sending the fault diagnosis result to a device associated with the sending device according to the obtained sending device identifier.

According to an embodiment of the present application,

the sending device is a diagnosis terminal;

the device associated with the sending device is a mobile device connected to the diagnosis terminal for presenting the fault diagnosis result to the vehicle owner.

By adopting the technical solutions provided by the present application, an onboard diagnosis terminal obtains vehicle status data in an ECU. If a fault occurs, a fault code can be sent to a diagnosis server at network side in real time so that the fault code can be diagnosed instantly. The diagnosis result is obtained and then is sent to the vehicle owner. The vehicle owner can know fault situation of the vehicle in time without moving the vehicle to a certain maintenance site, and further decide whether to make a repair or maintenance according to the obtained fault situation, which not only reduces the unnecessary time waste but also effectively reduces hidden trouble of security and reduces accident occurrence probability.

### BRIEF DESCRIPTION OF THE DRAWINGS

In order to explain the technical solutions of the embodiments of the present application or the prior art more clearly, the figures that are necessary for describing the embodiments of the present application or the prior art will be simply introduced one by one as follows. Obviously, the following figures show some embodiments of the present application, and those skilled in the art can obtain other figures based on these figures without exercise of any inventive labor.

FIG. 1a is a flow chart of a first method for vehicle diagnosis provided by an embodiment of the present application;

FIG. 1b is a flow chart of a second method for vehicle diagnosis provided by an embodiment of the present application;

FIG. 2 is a flow chart of a third method for vehicle diagnosis provided by an embodiment of the present application;

FIG. 3 is a flow chart of a forth method for vehicle diagnosis provided by an embodiment of the present application;

FIG. 4 is a block diagram of a diagnosis terminal provided by an embodiment of the present application;

FIG. 5 is a block diagram of a diagnosis server provided by an embodiment of the present application;

FIG. 6 is a block diagram of a system for vehicle diagnosis provided by an embodiment of the present application; and

FIG. 7 is a block diagram of another system for vehicle diagnosis provided by an embodiment of the present application.

### DETAILED DESCRIPTION OF THE EMBODIMENTS

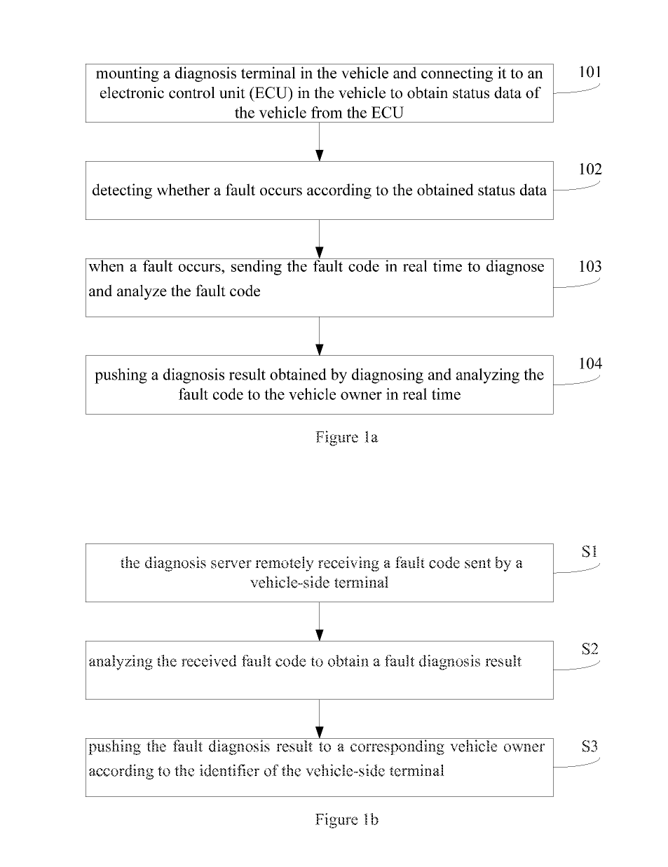

As shown in FIG. 1a, a method for vehicle diagnosis provided by the present application mainly comprises:

Step 101: mounting a diagnosis terminal in the vehicle and connecting it to an electronic control unit (ECU) in the vehicle to obtain status data of the vehicle from the ECU;

Step 102: detecting whether a fault occurs according to the obtained status data;

wherein, in case that the ECU detects that a fault occurs in the vehicle, it will generate a fault code corresponding to the fault, the fault code being a portion of the status data, and the diagnosis terminal can detect the fault code in the obtained status data;

Step 103: when the fault code is detected, the fault code is sent to a diagnosis server in real time so that the fault code can be diagnosed and analyzed by the diagnosis server;

Step 104: the diagnosis server pushing a diagnosis result obtained by diagnosing and analyzing the fault code to the vehicle owner in real time.

In order to further clarify the objects, technical solutions and advantages of the embodiments of the present application, the technical solutions in the embodiments of the present application will be described clearly and completely below in connection with the figures in the embodiments. Obviously, the embodiments described are some exemplified embodiments of the present application instead of all embodiments. Based on the embodiments of the present application, all the other embodiments obtained by those skilled in the art without exercise of any inventive labor are within the scope of protection of the present application.

### Embodiment 1

This embodiment explains the method of vehicle diagnosis provided by the present application from the perspective of the diagnosis server. As shown in FIG. 1b, the method comprises:

Step S1: the diagnosis server remotely receiving a fault code sent by a vehicle-side terminal;

In an embodiment of the present application, the vehicle-side terminal can be a diagnosis terminal mounted inside the vehicle, and the diagnosis terminal has a function of remote communication with a diagnosis server at network side. On the other hand, the diagnosis terminal can obtain status data inside the vehicle from the ECU, and judge whether a fault currently occurs in the vehicle according to whether the status data including a fault code. In case of determining that a fault currently occurs in the vehicle, the fault code is sent to the diagnosis server at network side.

In another embodiment of the present application, the vehicle-side terminal can also consists of two portions, a diagnosis terminal and a communication terminal, in which the communication terminal can be a device such as a mobile phone, a tablet computer, a notebook, etc., which has an own communication network access function, for example through 3G, WIFI, etc., and is capable of remote communication with a diagnosis server at network side. On the other hand, the communication terminal and the diagnosis terminal may communicate through a WIFI wireless local area network, Bluetooth, or a cable direct connection, etc. The diagnosis terminal can send the fault code to the communication terminal in an active or passive manner, and then the communication terminal may further upload the fault code to the diagnosis server at network side. Comparing with the above embodiment, this solution utilizes the communication network access function of the device such as the mobile phone, the tablet computer, etc., which avoids adding an additional communication module to the onboard terminal and effectively saves the cost. The device such as the mobile phone etc. not only is easy to carry but also has features of strong processing capability, good operability, good extendibility, etc., which may enable more functions and is easy to improve or update the functions through a manner such as upgrading software, etc. Of course, it may be understood that on the basis of this embodiment, it allows the diagnosis terminal to establish a connection with the device such as the mobile phone, the notebook, etc. while directly communicating with the diagnosis server in order to achieve more functions by utilizing the advantages of the processing capability, the operability, the extendibility, etc. of these devices.

After receiving the fault code sent by the vehicle-side terminal, the diagnosis server can distinguish the terminals of different vehicles or vehicle owners with certain identification information. The identification information may be a certain communication identifier of a communication device, for example, a MAC address, an IP address, etc., or the number of vehicle license, the number of driving license, or the user name registered by the vehicle owner, etc. In case that the identification information is not a communication identifier, it generally needs to send the identification information to the diagnosis server together with the fault code.

Step S2: analyzing the received fault code to obtain a fault diagnosis result;

After receiving the fault code sent by the vehicle-side, the diagnosis server can conduct an automatic analysis according to the data and information stored therein to obtain an actual fault description corresponding to the fault code. It can be understood that in order to make the fault diagnosis result more accurate and practical, it does not exclude a manual analysis or check.

Except for the description information about the fault, the diagnosis result may further include contents such as corresponding repair suggestion, repair site recommendation, etc. Moreover, it can be extended to include related information for providing the vehicle owner with convenient service, for example, value-added service contents such as weather forecast, real time traffic information, violation query, etc. In addition, the diagnosis result may be carried in a manner of text, table, picture, or even video and audio. In the present application, the contents included in the diagnosis result are not limited.

Step S3: pushing the fault diagnosis result to a corresponding vehicle owner according to the identifier of the vehicle-side terminal.

After obtaining the diagnosis result by analyzing, the diagnosis server pushes the diagnosis result to the vehicle owner in a certain manner so that the vehicle owner knows specific fault situation regarding the fault occurred in her/his own vehicle.

In an embodiment of the present application, the diagnosis server can return the fault diagnosis result to the sending device which sends the fault code. For example, if, in S1, the sending device which sends the fault code is a diagnosis terminal with a communication function, the diagnosis result is correspondingly returned to this diagnosis terminal in this step. If, in S1, the sending device which sends the fault code is a mobile phone of user, the diagnosis result is returned to this mobile phone in this step.

In another embodiment of the present application, the diagnosis server can send the fault diagnosis result to other devices associated with the sending device which sends the fault code. For example, if, in S1, the sending device which sends the fault code is a diagnosis terminal with a communication function, the diagnosis server may send the diagnosis result to a mobile phone, a tablet computer etc. connected with the diagnosis terminal in order to better present the fault diagnosis result to user in this step.

In another embodiment of the present application, the diagnosis server can inform the fault diagnosis result to the vehicle owner in other manners. For example, other contact information (e.g., the phone number, and email address) of the vehicle owner associated with the sending device which sends the fault code can be obtained according to the identifier of the sending device, and the information can be pre-stored in the server or can be requested to be provided by the vehicle owner when the fault code is uploaded. After analyzing the obtained diagnosis result, the diagnosis server can push the diagnosis result to the vehicle owner in a manner of text short message, multimedia message, email, etc., and, if necessary, the service personnel can directly contact the vehicle owner via telephone.

With the method of vehicle diagnosis provided by the present application, an onboard diagnosis terminal obtains vehicle status data in an ECU. If a fault occurs, a fault code can be sent to a diagnosis server at network side in real time so that it can be diagnosed instantly. The diagnosis result is obtained and then sent to the vehicle owner. The vehicle owner can know fault situation of the vehicle in time without moving the vehicle to a certain maintenance site, and further decide whether to make a repair or maintenance according to the obtained fault situation, which not only reduces the unnecessary time waste but also effectively reduces hidden trouble of security and reduces accident occurrence probability.

### Embodiment 2

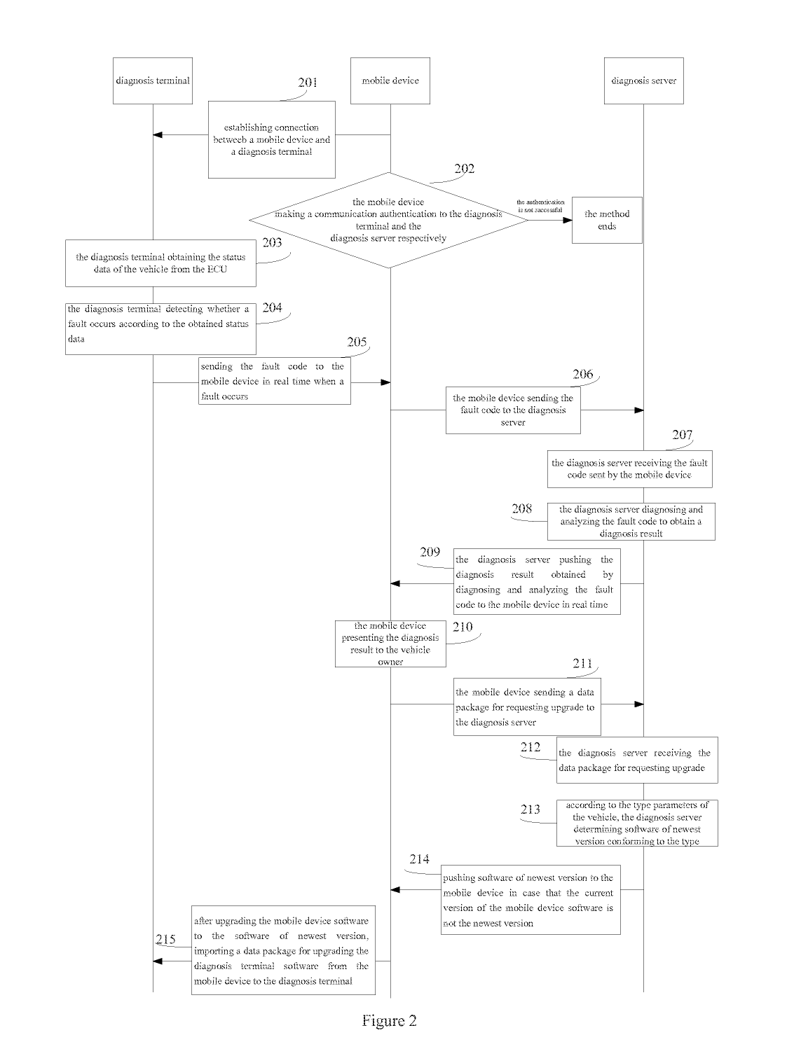

Embodiment 2 of the present application provides another method for vehicle diagnosis, which is a preferred embodiment of the method for vehicle diagnosis provided by the present application. Specifically, as shown in FIG. 2, the method mainly comprises an information interaction process of a mobile device, a diagnosis terminal, and a diagnosis server. The method comprises:

Step 201: establishing connection between a mobile device and a diagnosis terminal;

The diagnosis terminal is mounted in a vehicle and is connected with an electronic control unit (ECU) in the vehicle.

The mobile device is hold by the vehicle owner and may be a device such as a smart mobile phone, a tablet computer, a notebook computer, etc.

The mobile device and the diagnosis terminal can make a communication handshaking through Bluetooth, a WIFI wireless local area network, or a cable direct connection, etc. If the handshaking is successful, the connection is established, and otherwise, the handshaking can be tried more times.

In addition, the vehicle owner can manually stop the pairing process of the mobile device and the diagnosis terminal when they are making a communication handshaking.

Step 202: the mobile device making a communication authentication to the diagnosis terminal and the diagnosis server respectively; if the authentication is successful, the method proceeds to step 203, and otherwise, the method ends;

Step 203: the diagnosis terminal obtaining the status data of the vehicle from the ECU;

Step 204: the diagnosis terminal detecting whether a fault occurs according to the obtained status data;

wherein, when detecting a fault occurred in the vehicle, the ECU may generate a fault code corresponding to the fault. The fault code is a portion of the status data. If the diagnosis terminal detects a fault code in the obtained status data, a fault occurs in the vehicle.

Step 205: sending the fault code to the mobile device in real time when a fault occurs;

When determining a fault currently occurs in the vehicle, the diagnosis terminal extracts the fault code from the status data and sends the fault code to the mobile device in real time.

The fault code can be displayed on the mobile device. However, the fault code is a technical code in the technical field of vehicle, and generally it is difficult for a vehicle owner to know which kind of fault occurs in the vehicle according to the displayed fault code. In the embodiment, the fault code can be further sent to the diagnosis server to be diagnosed and analyzed in order to know the specific fault situation of the vehicle.

Step 206: the mobile device sending the fault code to the diagnosis server;

Step 207: the diagnosis server receiving the fault code sent by the mobile device;

Step 208: the diagnosis server diagnosing and analyzing the fault code to obtain a diagnosis result;

After receiving the fault code sent by the vehicle-side, the diagnosis server can automatically analyze it according to the data and information stored therein, so as to obtain an actual fault description corresponding to the fault code. It can be understood that, in order to make the fault diagnosis result more accurate and practical, it does not exclude manual analysis or check in above process.

Step 209: the diagnosis server pushing the diagnosis result obtained by diagnosing and analyzing the fault code to the mobile device in real time.

Step 210: the mobile device presenting the diagnosis result to the vehicle owner;

The diagnosis result is presented in an understandable manner to the vehicle owner such as a text interface, an instrument interface, a picture interface, etc., and the interfaces are presented with client terminal software installed on the mobile device. The diagnosis result may further include repair suggestion, repair site recommendation as well as some related information for providing the vehicle owner with convenient service, for example, value-added service contents such as weather forecast, real time traffic information, illegal search, etc. After knowing the diagnosis result, the vehicle owner can decide whether to make a repair to the vehicle.

Thus, the vehicle owner can know the fault situation of the vehicle conveniently in time by the fact that the diagnosis server pushes related service contents such as fault information, repair suggestion, etc. to the vehicle owner, and can have the vehicle repaired according to the repair suggestions, thereby the driving security of the vehicle owner may be guaranteed.

In addition, the diagnosis server can pre-stored fault code information corresponding to each type of vehicle, which corresponds to the number of vehicle license and the owner information of each vehicle, in which the owner information includes the name of the owner, contact information, etc. Thus, when the mobile device sends a fault code to the diagnosis server, the diagnosis server can identify the vehicle corresponding to the fault code according to the sender of the fault code, and thereby push the diagnosis result obtained by diagnosis and analysis to the vehicle owner via a message or a mail according to the contact information corresponding to the vehicle owner.

After diagnosing and analyzing the obtained diagnosis result, the diagnosis server can further store the diagnosis result for review of the vehicle owner in any time.

As shown in FIG. 2, the embodiment further provides a method for upgrading software of the mobile device and the diagnosis terminal:

Step 211: the mobile device sending an data package for requesting upgrade to the diagnosis server;

The data package carries type parameters of the vehicle and version parameters of the mobile device software.

Step 212: the diagnosis server receiving the data package for requesting upgrade;

Step 213: according to the type parameters of the vehicle, the diagnosis server determining software of newest version conforming to the type;

Step 214: pushing software of newest version to the mobile device in case that the current version of the mobile device software is not the newest version.

After upgrading the mobile device software, there needs to further upgrade the embedded program in the diagnosis terminal software connected with it. Specifically, the method further comprises:

Step 215: after upgrading the mobile device software to the software of newest version, importing a data package for upgrading the diagnosis terminal software from the mobile device to the diagnosis terminal to complete the upgrade of the diagnosis terminal software.

It can be understood that due to the difference of hardware, operation system, etc., the contents installed in the mobile device and the diagnosis terminal are not identical completely. Indeed, the upgrade data package sent by the diagnosis server to the mobile device includes sub data packages for upgrading the mobile device and the diagnosis terminal respectively. Since the diagnosis server is not directly interacted with other device during diagnosis, the diagnosis server firstly sends the two sub data packages to the mobile device at the same time in the software upgrade process. After completing the upgrade process, the mobile device imports the data package for upgrading the diagnosis terminal software to the diagnosis terminal. Thus, the synchronous updating of the mobile device software and the diagnosis terminal software can be achieved.

It can be understood that the flow of the method for diagnosis described in steps 201-210 is independent of the flow of the method for software upgrade described in steps 211-215. For convenience of illustration, these two flows are depicted in the same figure. However, the solution shown in FIG. 2 shall not be considered as a limitation to the diagnosis flow and the software upgrade flow.

In the embodiment, the mobile device installs diagnosis software therein and makes a communication handshaking with a hardware diagnosis terminal mounted in the vehicle through a wireless communication technique such as Bluetooth, WIFI, etc. The mobile device calls a diagnosis program to inform the diagnosis terminal to detect the vehicle. The detected fault code is returned to the mobile device software. The mobile device software transmits the fault code to the diagnosis server through a mobile network so that the fault code can be diagnosed and analyzed. The diagnosis server transmits back the diagnosis result obtained by the diagnosis and analysis to the mobile device software in a manner of multimedia message, short message, or network information, etc., so that the vehicle owner can know the current vehicle health situation via the diagnosis result.

In the embodiment, the diagnosis server communicates with the mobile device, and the diagnosis server does not directly communicate with the diagnosis terminal. Therefore, in the software upgrade process, the diagnosis server firstly sends an upgrade data package to the mobile device. After completing upgrade, the mobile device imports the data package for upgrading the diagnosis terminal software to the diagnosis terminal. Then, the synchronous updating of the mobile device software and the diagnosis terminal software may be achieved.

### Embodiment 3

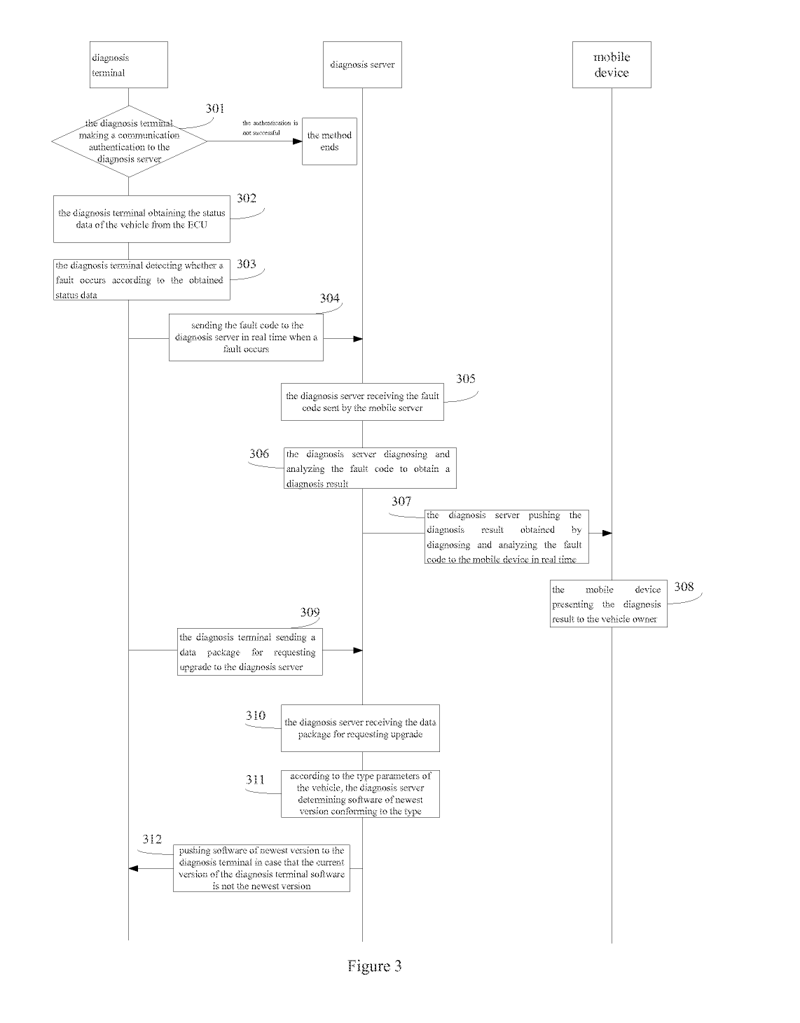

Embodiment 3 of the present application provides another method for vehicle diagnosis, which is another preferred embodiment of the method for vehicle diagnosis provided by the present application. The method mainly comprises an information interaction process of a diagnosis terminal and a diagnosis server, and using a mobile device as a presenting platform. As shown in FIG. 3a, the method comprises:

Step 301: the diagnosis terminal making a communication authentication to the diagnosis server; if the authentication is successful, the method proceeds to step 302, and otherwise, the method ends.

The diagnosis terminal and the diagnosis server remotely connect to each other in a wireless manner.

Step 302: the diagnosis terminal obtaining the status data of the vehicle from the ECU;

The diagnosis terminal is mounted in a vehicle, and is connected to the electronic control unit in a vehicle.

Step 303: the diagnosis terminal detecting whether a fault occurs according to the obtained status data;

When detecting a fault occurred in the vehicle, the ECU can generate a fault code corresponding to the fault. The fault code is a portion of the status data. If the diagnosis terminal detects a fault code in the obtained status data, a fault occurs in the vehicle.

Step 304: sending the fault code to the diagnosis server in real time when a fault occurs;

When determining a fault currently occurs in the vehicle, the diagnosis terminal extracts the fault code from the status data and sends the fault code to the diagnosis server in real time.

Step 305: the diagnosis server receiving the fault code sent by the diagnosis terminal;

Step 306: the diagnosis server diagnosing and analyzing the fault code to obtain a diagnosis result;

After receiving the fault code sent by the vehicle-side, the diagnosis server can automatically analyze it according to the data and information stored therein to obtain an actual fault description corresponding to the fault code. It can be understood that in order to make the fault diagnosis result more accurate and practical, it does not exclude a manual analysis or check in above process.

Step 307: the diagnosis server pushing the diagnosis result obtained by diagnosing and analyzing the fault code to the mobile device in real time;

Step 308: the mobile device presenting the diagnosis result to the vehicle owner;

The diagnosis result is presented in an understandable manner to the vehicle owner such as a text interface, an instrument interface, a picture interface, etc., and the interfaces are presented with client terminal software installed on the mobile device. The diagnosis result can further include repair suggestion, repair site recommendation, as well as some related information for providing the vehicle owner with convenient services, for example, value-added service contents such as weather forecast, real time traffic information, illegal search, etc. After knowing the diagnosis result, the vehicle owner can decide whether to make a repair to the vehicle.

Thus, the vehicle owner can know the fault situation of the vehicle conveniently in time by the fact that diagnosis server pushes related service content such as fault information, repair suggestion, etc. to the vehicle owner, and can have the vehicle repaired according to the repair suggestion, thereby the driving security of the vehicle owner can be guaranteed.

In addition, the diagnosis server stores fault code information corresponding to each type of vehicle, which corresponds to the number of vehicle license and the owner information of each vehicle, in which the owner information includes the name of the owner, contact information, etc. Thus, when the mobile device sends a fault code to the diagnosis server, the diagnosis server may identify the vehicle corresponding to the fault code according to the sender of the fault code, and thereby push the diagnosis result obtained by diagnosis and analysis to the vehicle owner via a short message or a multimedia message according to the contact information corresponding to the vehicle owner.

As shown in FIG. 3, the embodiment of the present application further provides a method for upgrading software of the mobile device and the diagnosis terminal:

Step 309: the diagnosis terminal sending an data package for requesting upgrade to the diagnosis server;

The data package carries type parameters of the vehicle and version parameters of the mobile device software.

Step 310: the diagnosis server receiving the data package for requesting upgrade;

Step 311: according to the type parameters of the vehicle, the diagnosis server determining software of newest version conforming to the type;

Step 312: pushing software of newest version to the diagnosis terminal in case that the current version of the diagnosis terminal software is not the newest version.

It can be understood that the flow of the method for diagnosis described in steps 301-308 is independent of the flow of the method for software upgrade described in steps 309-312. For convenience of illustration, these two flows are depicted in one figure. However, the solution shown in FIG. 3 shall not be considered as a limitation to the diagnosis flow and the software upgrade flow.

In the embodiment, the mobile device does not directly communicate with the diagnosis terminal. After detecting the vehicle, the diagnosis terminal makes a direct data interaction with the diagnosis server. The upgrade of the version of the diagnosis terminal software is also directly done with the diagnosis server. Finally, the diagnosis result of the diagnosis server is pushed to the mobile device in a manner of multimedia message, short message, network information, etc., so that the vehicle owner can know the current vehicle health situation via the diagnosis result.

In the embodiment, the diagnosis server communicates with the diagnosis terminal, and the mobile device is only used to present the diagnosis result. Therefore, in the software upgrade process, the software of the diagnosis terminal can be upgraded once the diagnosis server directly sending the upgrade data package to the diagnosis terminal

### Embodiment 4

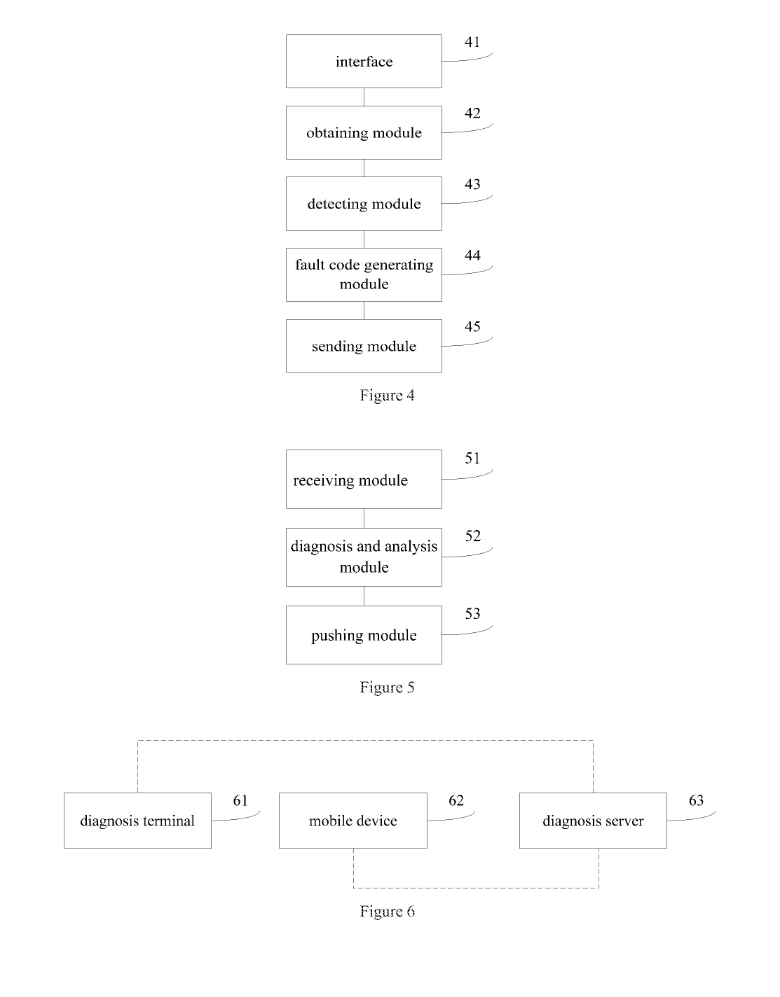

Embodiment 4 of the present application provides a diagnosis terminal As shown in FIG. 4, it comprises:

an interface 41 for connecting to an electronic control unit (ECU) in a vehicle;

an obtaining module 42 for obtaining status data of the vehicle from the ECU through the interface;

a detecting module 43 for detecting whether a fault occurs according to the obtained status data;

wherein, when detecting a fault occurred in the vehicle, the ECU will generate a fault code corresponding to the fault. The fault code is a portion of the status data. If the detecting module 43 detects a fault code in the obtained status data, a fault occurs in the vehicle.

a fault code generating module 44 for extracting a fault code from the status data when determining a fault currently occurs in the vehicle;

a sending module 45 for sending the fault code in real time so that the fault code can be diagnosed and analyzed.

### Embodiment 5

With respect to Embodiment 1, Embodiment 5 of the present application provides a diagnosis server. As shown in FIG. 5, it comprises:

a receiving module 51 for remotely receiving a fault code sent by a vehicle-side terminal and recording a sending device identifier;

a diagnosis and analysis module 52 for analyzing the received fault code to obtain a fault diagnosis result;

a pushing module 53 for pushing the fault diagnosis result to a corresponding vehicle owner according to the sending device identifier.

In an embodiment of the present application, the pushing module 53 can comprise:

a device identifier obtaining sub-module for obtaining the sending device identifier,

a pushing sub-module for returning the fault diagnosis result to a sending device according to the obtained sending device identifier.

For example, if the sending device for sending the fault code is a diagnosis terminal with a communication function, the pushing module 53 correspondingly returns the diagnosis result to this diagnosis terminal. If the sending device for sending the fault code is a mobile phone of user, the pushing module 53 returns the diagnosis result to this mobile phone.

In another embodiment of the present application, the pushing module 53 can also comprise:

a device identifier obtaining sub-module for obtaining the sending device identifier,

a pushing sub-module for sending the fault diagnosis result to a device associated with the sending device according to the obtained sending device identifier.

For example, if the sending device for sending the fault code is a diagnosis terminal with a communication function, the pushing module 53 can send the diagnosis result to a mobile phone, a tablet computer, etc. connected with the diagnosis terminal in order to better present the fault diagnosis result to user.

In another embodiment of the present application, the pushing module 53 can also comprise:

a contact information obtaining sub-module for, according to the sending device identifier, obtaining contact information of the vehicle owner associated with the device;

a pushing sub-module for, according to the obtained vehicle owner contact information, pushing the fault diagnosis result to the corresponding vehicle owner.

For example, according to the identifier of the sending device which sends the fault code, other contact information (such as telephone number, email address, etc.) of the vehicle owner associated with the device can be obtained and the information can be pre-stored in the server, or can be requested to be provided by the vehicle owner when uploading the fault code. After analyzing the obtained diagnosis result, the diagnosis server can push the diagnosis result to the vehicle owner in a manner of text short message, multimedia message, email, etc., and the service personnel can directly contact with the vehicle owner via telephone if necessary.

### Embodiment 6

With respect to Embodiment 3, Embodiment 6 of the present application provides a system for vehicle diagnosis. As shown in FIG. 6, it comprises a diagnosis terminal 61, a mobile device 62, and a diagnosis server 63.

The diagnosis terminal 61 is mounted in the vehicle and connected to an electronic control unit (ECU) in the vehicle.

The diagnosis terminal 61 is used to obtain status data of the vehicle from the ECU and detect whether a fault occurs according to the obtained status data. If a fault code is detected in the obtained status data, a fault occurs in the vehicle. When a fault occurs, the fault code is sent to the diagnosis server 63.

The diagnosis server 63 is used to receive the fault code sent by the diagnosis terminal and obtain the diagnosis result by diagnosing and analyzing the fault code, and push the diagnosis result to the mobile device 62 in real time.

### Embodiment 7

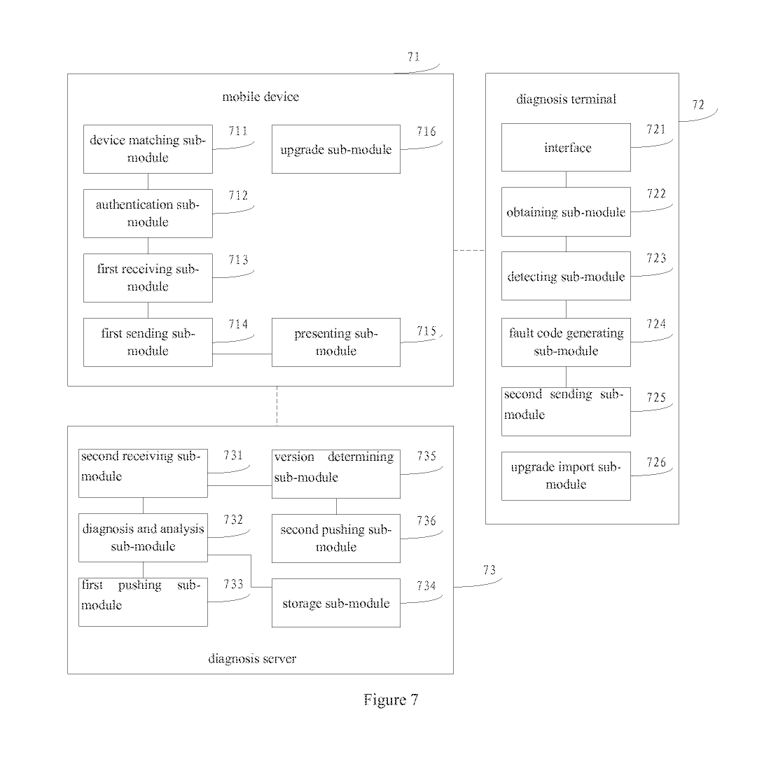

With respect to Embodiment 2, Embodiment 7 of the present application provides another system for vehicle diagnosis. As shown in FIG. 7, it comprises a mobile device 71, a diagnosis terminal 72, and a diagnosis server 73. Preferably, in the embodiment, the mobile device 71 connects to the diagnosis terminal 72 through Bluetooth, and the mobile device 71 connects to the diagnosis server 73 through a WIFI wireless local area network.

The mobile device 71 comprises a device matching sub-module 711, an authentication sub-module 712, a first receiving sub-module 713, a first sending sub-module 714, a presenting sub-module 715, and an upgrade sub-module 716.

The device matching sub-module 711 is used to establish a connection between the mobile device and the diagnosis terminal

The authentication sub-module 712 is used for the mobile device making a communication authentication to the diagnosis terminal and the diagnosis server respectively. If the authentication is successful, the communication is started.

The first receiving sub-module 713 is used to receive a fault code sent by the diagnosis terminal.

The first sending sub-module 714 is used to send the received fault code to the diagnosis server.

The presenting sub-module 715 is used to receive a diagnosis result sent by the diagnosis server and then present the diagnosis result to the vehicle owner.

The upgrade sub-module 716 is used to send a data package for requesting upgrade to the diagnosis server and make a software upgrade after receiving software of newest version pushed by the diagnosis server.

The diagnosis terminal 72 is mounted in the vehicle and is connected to an electronic control unit (ECU). It comprises an interface 721, an obtaining sub-module 722, a detecting sub-module 723, a fault code generating sub-module 724, a second sending sub-module 725, and an upgrade import sub-module 726.

The interface 721 is used to connect to the ECU in the vehicle.

The obtaining sub-module 722 is used to obtain status data of the vehicle from the ECU via the interface 721.

The detecting sub-module 723 is used to detect whether a fault occurs according to the obtained status data. In case that the ECU detects that a fault occurs in the vehicle, it will generate a fault code corresponding to the fault, the fault code being a portion of the status data. If the detecting sub-module 723 detects the fault code in the obtained status data, a fault occurs in the vehicle.

The fault code generating sub-module 724 is used to extract the fault code from the status data after it is determined that a fault currently occurs in the vehicle.

The second sending sub-module 725 is used to send the fault code to the mobile device in real time.

The upgrade import sub-module 726 is used to import a data package for upgrading the diagnosis terminal software from the mobile device after the mobile device software is upgraded to software of newest version.

The diagnosis server 73 comprises a second receiving sub-module 731, a diagnosis and analysis sub-module 732, a first pushing sub-module 733, a storage sub-module 734, a version determining sub-module 735, and a second pushing sub-module 736.

The second receiving sub-module 731 is used to receive a fault code sent by the mobile device and to receive a data package for requesting upgrade.

The diagnosis and analysis sub-module 732 is used to diagnosing and analyzing the fault code to obtain a diagnosis result.

The first pushing sub-module 733 is used to push the diagnosis result obtained by diagnosing and analyzing the fault code to the mobile device in real time.

The storage sub-module 734 is used to store the diagnosis result obtained by diagnosing and analyzing the fault code for review of the vehicle owner in any time.

The version determining sub-module 735 is used to, according to type parameters of the vehicle, determine software of newest version conforming to the type.

The second pushing sub-module 736 is used to push software of newest version to the mobile device in case that the current version of the mobile device software is not the newest version.

Those skilled in the art can understand that all of or a portion of the steps for implementing the above method embodiments can be completed by a program instructing related hardware. The program can be stored in a computer readable storage medium. The program can perform the steps of the above method embodiments when being executed. The storage medium includes various medium capable of storing program code such as ROM, RAM, magnetic disk, optical disk, etc.

It shall be noted that the above embodiments are only intended to explain the technical solutions of the present application, and do not constitute a limitation to the present application. Although the present application is described in detail with reference to the above embodiments, those skilled in the art shall understand that modifications may be made to the technical solutions recited in the above embodiments, or a portion of the technical features of the above embodiments can be substituted with equivalent features. However, such modifications or substitutions do not depart the substance of the corresponding technical solution form the spirit and scope of the technical solutions of the embodiments of the present application.

1. A method for vehicle diagnosis, comprising:
after a remote communication connection between a diagnosis server and a vehicle-side terminal being established, the diagnosis server remotely receiving a fault code sent by the vehicle-side terminal and recording a sending device identifier, wherein the vehicle-side terminal obtains the fault code from an electronic control unit in a vehicle;
analyzing the received fault code to obtain a fault diagnosis result;
pushing the fault diagnosis result to a corresponding vehicle owner according to the sending device identifier.

2. The method of claim 1, wherein the vehicle-side terminal comprises a diagnosis terminal, and
the diagnosis server remotely receiving the fault code sent by the vehicle-side terminal comprises:
after a remote communication connection between the diagnosis server and the diagnosis terminal is established, receiving the fault code sent by the diagnosis terminal.

3. The method of claim 1, wherein the vehicle-side terminal comprises a diagnosis terminal and a communication terminal, and
the diagnosis server remotely receiving the fault code sent by the vehicle-side terminal comprises:
after a remote communication connection between the diagnosis server and the communication terminal is established, receiving the fault code sent by the communication terminal;
wherein, the communication terminal obtains the fault code from the diagnosis terminal.

4. The method of claim 1, wherein the pushing of the fault diagnosis result to the corresponding vehicle owner according to the sending device identifier comprises:
returning the fault diagnosis result to the sending device according to the sending device identifier.

5. The method of claim 1, wherein the pushing the fault diagnosis result to the corresponding vehicle owner according to the sending device identifier comprises:
sending the fault diagnosis result to a device associated with the sending device according to the sending device identifier.

6. The method of claim 5, wherein
the sending device is a diagnosis terminal;
the device associated with the sending device is a mobile device connected to the diagnosis terminal for presenting the fault diagnosis result to the vehicle owner.

7. The method of claim 1, wherein the pushing of the fault diagnosis result to the corresponding vehicle owner according to the sending device identifier comprises:
obtaining contact information of the vehicle owner associated with the device according to the sending device identifier;
pushing the fault diagnosis result to the corresponding vehicle owner according to the obtained vehicle owner contact information.

8. The method of claim 2, further comprises:
receiving an data package for requesting upgrade sent by a diagnosis terminal, wherein the data package carries type parameters of a vehicle and version parameters of a diagnosis terminal software;
determining software of newest version conforming to the type according to the type parameters of the vehicle;
pushing software of newest version to the diagnosis terminal in case that the current version of the diagnosis terminal software is not the newest version.

9. The method of claim 3, further comprises:
receiving an data package for requesting upgrade sent by a communication terminal, wherein the data package carries type parameters of a vehicle and version parameters of a communication terminal software;
determining software of newest version conforming to the type according to the type parameters of the vehicle;
pushing software of newest version to the communication terminal if the current version of the communication terminal software is not the newest version.

10. The method of claim 9, further comprises:
after upgrading the communication terminal software to the software of newest version, importing a data package for upgrading the diagnosis terminal software from the communication terminal to the diagnosis terminal.

11. A server for vehicle diagnosis comprising:
a receiving module for, after a remote communication connection between a diagnosis server and a vehicle-side terminal is established, remotely receiving a fault code sent by the vehicle-side terminal and recording a sending device identifier, wherein the vehicle-side terminal obtains the fault code from an electronic control unit in a vehicle;
a diagnosis and analysis module for analyzing the received fault code to obtain a fault diagnosis result;
a pushing module for pushing the fault diagnosis result to a corresponding vehicle owner according to the sending device identifier.

12. The server for vehicle diagnosis of claim 11, wherein the pushing module comprises:
a device identifier obtaining sub-module for obtaining the sending device identifier,
a pushing sub-module for returning the fault diagnosis result to the sending device according to the obtained sending device identifier.

13. The server for vehicle diagnosis of claim 11, wherein the pushing module comprises:
a device identifier obtaining sub-module for obtaining the sending device identifier,
a pushing sub-module for sending the fault diagnosis result to a device associated with the sending device according to the obtained sending device identifier.

14. The server for vehicle diagnosis of claim 13, wherein
the sending device is a diagnosis terminal;
the device associated with the sending device is a mobile device connected to the diagnosis terminal for presenting the fault diagnosis result to the vehicle owner.

15. The server for vehicle diagnosis of claim 11, wherein the pushing module comprises:
a contact information obtaining sub-module for, according to the sending device identifier, obtaining contact information of the vehicle owner associated with the device;
a pushing sub-module for, according to the obtained vehicle owner contact information, pushing the fault diagnosis result to the corresponding vehicle owner.

16. A system for vehicle diagnosis, comprising:
a vehicle-side terminal for sending a fault code to a diagnosis server after determining a fault occurred in a vehicle;
the diagnosis server comprising:
a receiving module for, after a remote communication connection between the diagnosis server and the vehicle-side terminal is established, remotely receiving the fault code sent by the vehicle-side terminal and recording a sending device identifier, wherein the vehicle-side terminal obtains the fault code from an electronic control unit in a vehicle;
a diagnosis and analysis module for analyzing the received fault code to obtain a fault diagnosis result;
a pushing module for pushing the fault diagnosis result to a corresponding vehicle owner according to the sending device identifier.

17. The system for vehicle diagnosis of claim 16, wherein the vehicle-side terminal comprises a diagnosis terminal, wherein,
after establishing a remote communication connection to the diagnosis server, the diagnosis terminal sends the fault code to the diagnosis server.

18. The system for vehicle diagnosis of claim 16, wherein the vehicle-side terminal comprises a diagnosis terminal and a communication terminal,
the communication terminal obtains the fault code from the diagnosis terminal;
after establishing a remote communication connection to the diagnosis server, the communication terminal sends the fault code to the diagnosis server.

19. The system for vehicle diagnosis of claim 16, wherein the pushing module comprises:
a device identifier obtaining sub-module for obtaining the sending device identifier,
a pushing sub-module for sending the fault diagnosis result to a device associated with the sending device according to the obtained sending device identifier.

20. The system for vehicle diagnosis of claim 19, wherein
the sending device is a diagnosis terminal;
the device associated with the sending device is a mobile device connected to the diagnosis terminal for presenting the fault diagnosis result to the vehicle owner.
